(19) United States
(12) Patent Application Publication
(10) Pub. No.: US 2008/0155696 A1
(43) Pub. Date: Jun. 26, 2008

(54) System and Method for Enhanced Malware Detection

(75) Inventors: William H. Dudley, Lovettsville, VA (US); Robert C. Lovell, Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Chantilly, VA (US)

(21) Appl. No.: 11/958,759

(22) Filed: Dec. 18, 2007

Related U.S. Application Data
(60) Provisional application No. 60/876,524, filed on Dec. 22, 2006.

(51) Int. Cl. G06F 11/00

(52) U.S. Cl. 726/24

(57) ABSTRACT

A service that leverages a flexible, extensible, and dynamically configurable Message Evaluation Framework to provide comprehensive malware detection and optional malware elimination capabilities within established wireless messaging paradigms such as, possibly inter alia, Multimedia Message Service, Wireless Application Protocol, and IP Multimedia Subsystem. The service may optionally leverage the capabilities of a centrally-located Messaging Inter-Carrier Vendor.

This application claims the benefit of U.S. Provisional Patent Application No. 60/876,524, filed on Dec. 22, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various messaging paradigms including, inter alia, Multimedia Message Service (MMS), Wireless Application Protocol (WAP), Internet Protocol (IP) Multimedia Subsystem (IMS), etc.

2. Background of the Invention

As the ‘wireless revolution’ continues to march forward the importance to a Mobile Subscriber (MS), for example a user of a Wireless Device (WD)—such as, inter alia, a mobile telephone, a BlackBerry, etc. that is serviced by a Wireless Carrier (WC)—of their WD grows substantially. One consequence of such a growing importance is the resulting ubiquitous nature of WDs—i.e., MSs carry them at almost all times and use them for an ever-increasing range of activities.

As MSs employ their WDs for ever more activities their WDs become increasingly more vulnerable to a range of undesirable behaviors. One undesirable behavior may be labeled malware (i.e., malicious software or ‘computer contaminant’) and may be considered to include entities such as, possibly inter alia, viruses, worms, Trojan horses, spyware, etc.

The transit of malware via Electronic Mail (E-mail) and other mechanisms over the Internet has become notorious. Numerous efforts or initiatives have arisen in response to the growth of Internet-based malware including, inter alia, purely technical efforts (such as, e.g., commercial, freeware, and open source filters) and legal initiatives.

A confluence of several factors, including:

1) The rapidly expanding universe of target WDs (e.g., there are now over two billion mobile devices throughout the world).

2) The utilization of WDs (as described above) for increasingly more valuable purposes (such as, inter alia, ‘mobile wallet’ and payment vehicles).

3) The evolving sophistication of malware artists.

has led, perhaps inevitably, to malware artists targeting WDs within wireless messaging ecosystems.

The first instance of mobile malware, the Cabir virus, was detected in mid-2004. By late-2006 over 300 different instances of mobile malware had been identified and cataloged with the rate of increase (of the discovery of new instances of malware) itself rising rapidly. (See, for example, the article “Malware Goes Mobile” in the November 2006 edition of Scientific American.)

As a result, a range of new, enhanced anti-malware mechanisms are necessary to identify or detect, and optionally eliminate, malware within a wireless messaging ecosystem.

The present invention provides such enhanced malware detection and elimination capabilities and addresses various of the (not insubstantial) challenges that are associated with same.

### SUMMARY OF THE INVENTION

Embodiments of the present invention employ a flexible, extensible, and dynamically configurable Message Evaluation Framework (MEF) to provide comprehensive malware detection and optional malware elimination capabilities within established wireless messaging paradigms such as, possibly inter alia, MMS, IMS, etc.

More particularly, embodiments of the present invention provide a method for detecting malware within messages that are transiting a wireless network. The method includes intercepting, at a Messaging Inter-Carrier Vendor (MICV), a message that was sent over a wireless network. The message is passed to an application server that is in communication with a database. The application server then calculates a probability that the message contains malware. Preferably, the probability calculation takes into account, among other things, aspects of the content of the message.

In accordance with embodiments of the present invention a Sensitivity Factor (SF)—which may be based on one or more of a source address of the message, a source carrier of the message, a frequency count, and/or a time of day or day of week that the message was sent—may be included in a probability calculation.

If a given message is determined to contain malware then the message may be dropped, cleansed (optionally using Phantom Content), or quarantined. Additionally one or more alert messages may be generated and sent.

If Phantom Content is used to replace the malware in the message, the message may again be passed to the application server for a re-calculation of the probability the message with the now-excised malware content contains malware.

These and other features of the embodiments of the present invention, along with their attendant advantages, will be more fully appreciated upon a reading of the following detailed description in conjunction with the associated drawings.

### BRIEF DESCRIPTION OF THE DRAWINGS

FIG. 1 is a diagrammatic presentation of an exemplary MICV.

FIG. 2 illustrates one particular arrangement that is possible through aspects of the present invention.

FIG. 3 illustrates an exemplary sliding window facility that may be employed by aspects of the present invention.

FIG. 4 illustrates an exemplary MEF.

FIG. 5 illustrates various of the exchanges or interactions that are supported by aspects of the present invention.

FIG. 6 is a diagrammatic presentation of aspects of an exemplary Service Provider (SP) Application Server (AS).

It should be understood that these figures depict embodiments of the invention. Variations of these embodiments will be apparent to persons skilled in the relevant art(s) based on the teachings contained herein.

### DETAILED DESCRIPTION

The present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same. The disclosure of U.S. Pat. No. 7,154,901, along with its associated continuations, is incorporated herein by reference.

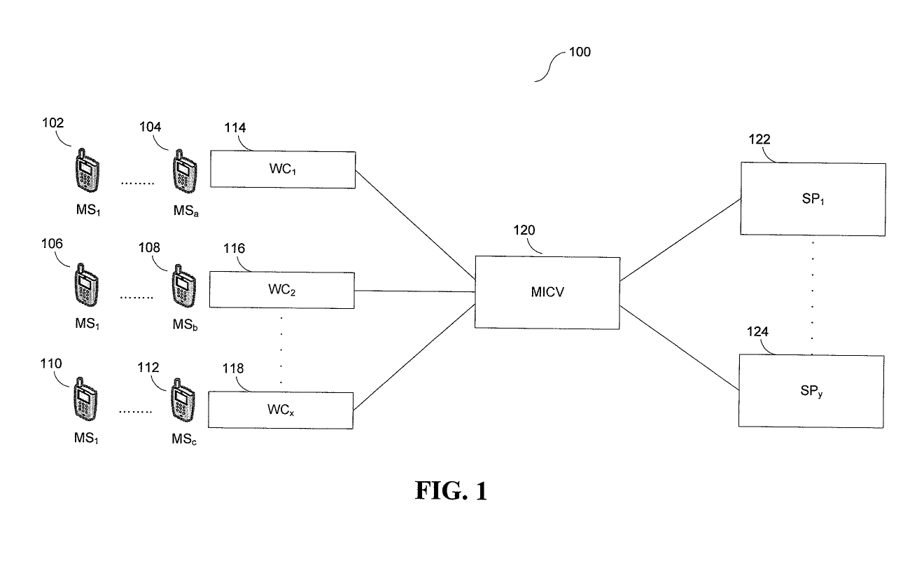

As illustrated in FIG. 1 and reference numeral 100 a MICV 120 is disposed between, possibly inter alia, multiple WCs (WC₁ 114→WCₓ 118) on one side and multiple SPs (SP₁ 122→SP_{y} 124) on the other side and thus ‘bridges’ all of the connected entities. A MICV 120 thus, as one simple example, may offer various routing, formatting, delivery, value-add, etc. capabilities that provide, possibly inter alia:

1) A WC 114→118 (and, by extension, all of the MSs 102→104, 106→108, and 110→112 that are serviced by the WC 114→118) with ubiquitous access to a broad universe of SPs 122→124 and

2) A SP 122→124 with ubiquitous access to a broad universe of WCs 114→118 (and, by extension, all of the MSs 102→104, 106→108, and 110→112 that are serviced by the WC 114→118).

Generally speaking a MICV may have varying degrees of visibility (e.g., access, etc.) to the (MS← →MS, MS← →SP, etc.) messaging traffic:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

An implementation that contains a ‘route all of their messaging traffic to a MICV’ option may serve to enhance aspects of the present invention.

While the discussion below will include a MICV it will be readily apparent to one of ordinary skill in the relevant art that other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

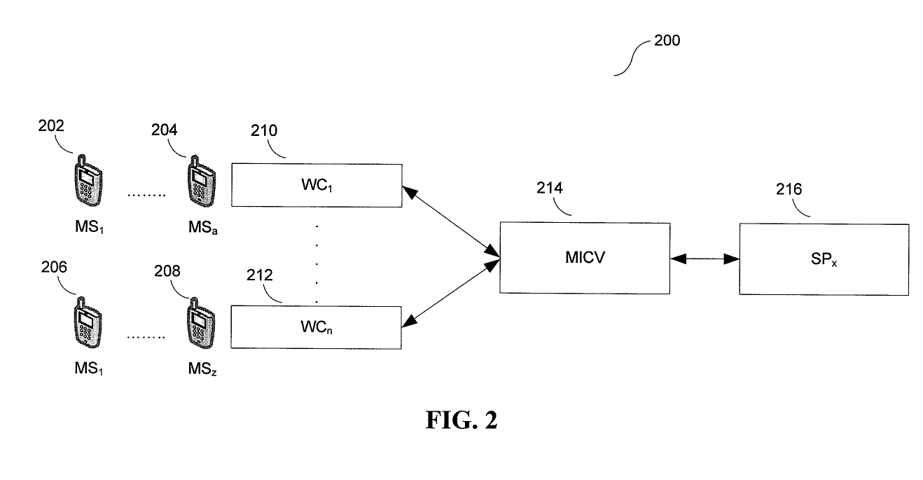

To help explain key aspects of the present invention consider the illustrative example that is depicted through FIG. 2 and the narrative below.

As indicated in FIG. 2 and reference numeral 200 all of the messaging traffic of numerous WCs (WC₁ 210→WCₙ 212) is exchanged with a MICV 214 and the MICV 214 is connected with SPₓ 216 (a SP that offers, possibly inter alia, the present invention). Among other things this provides SPₓ 216 with visibility (access, etc.) to all of the messaging traffic (to, possibly inter alia, conduct malware detection operations against all of that traffic) and, inter alia, the opportunity (as explained below) to continuously expand its internal repositories, refine the results of its message review and other analytical activities, etc. as time progresses (and as ever more messages are presented to it).

Aspects of the present invention include a flexible, extensible, and dynamically configurable MEF. As explained below, a MEF (possibly inter alia) may accept as input an incoming (MMS, etc.) message, apply to the accepted message various rules/logic/data/etc., and generate as output a Malware Probability (MP) (i.e., a probability that the message may be infected with one or more instances of malware).

It will be readily apparent to one of ordinary skill in the art that a calculated MP may take a number of different forms. For example, possibly inter alia:

1) A MP may be defined as a scalar value that lies within the range 0<=MP<=1 (with the boundary values of 0 and 1 indicating the absolute or authoritative conditions ‘malware not detected’ [for 0] and ‘malware detected’ [for 1]).

2) A MP may be defined as a vector, matrix, etc. where each element of same is, possibly inter alia, allowed to span a wider range of values (with, possibly inter alia, an associated modulus or other scaling mechanism to ensure that a final or end calculated value never exceeds a configurable range such as, inter alia, 0%→100%) for cases where, possibly inter alia, multiple instances of malware are detected in a single message; it is desirable to preserve multiple attributes (such as, for example, type, location, etc.) for each instance of malware detection in a message; etc.

A MEF may contain, possibly inter alia:

1) A suite of dynamically updateable Mobile Malware Signature Files (MMSFs). A MMSF may contain, possibly inter alia, lineage or ancestry information (including, possibly among other things, creator identification, creation date and time, version number, etc.); a variable-sized binary pattern that is indicative of a mobile virus, worm, Trojan horse, piece of spyware; verification information (such as, possibly among other things, a checksum value); etc.

A particular piece of malware may be indicated by, or codified through, one or more MMSFs.

A single MMSF may indicate or codify one or more pieces of malware.

MMSFs may, possibly inter alia, be created or defined internally by SPₓ (for example, in response to the appearance of new malware during SPₓ's processing of messages); be culled from publicly available freeware, shareware, etc. sources; be licensed from commercial, open source, etc. parties (such as, among others, McAfee and Symantec); etc.

A MMSF may be defined as being unique to one specific messaging paradigm (e.g., MMS, IMS, etc.), being applicable to a specific set of messaging paradigms (e.g., as one possible example, MMS and WAP), or being applicable to all of the different messaging paradigms that are supported by SPX.

The MMSF characteristics that were described above are illustrative only and it will be readily apparent to one of ordinary skill in the relevant art that numerous other options are easily possible and indeed are fully within the scope of the present invention.

2) An optional MMSF normalization facility to equalize or otherwise normalize the content, format, structure, etc. of disparate MMSFs. Such a facility may provide the MEF with, possibly inter alia, operational efficiencies through the use of just one internal, proprietary or open, malware signature format, structure, etc.

3) A SF to indicate the relative importance, likelihood of infection, etc. for a (MMS, etc.) message based on ‘extra’ criteria. For example, a SF may consist of a defined group of, and therefore be calculated or generated by evaluating, one or more of the elements within a flexible, extensible, and dynamically updateable or configurable suite of elements. Potential SF elements might include, possibly inter alia:

i) Source Address (SA). For example one specific message SA (such as, for example, the source Telephone Number [TN], source Short Code [SC] or Common Short Code [CSC], etc.). Or a mix or collection of specific SAs. Or an explicit range of SAs.

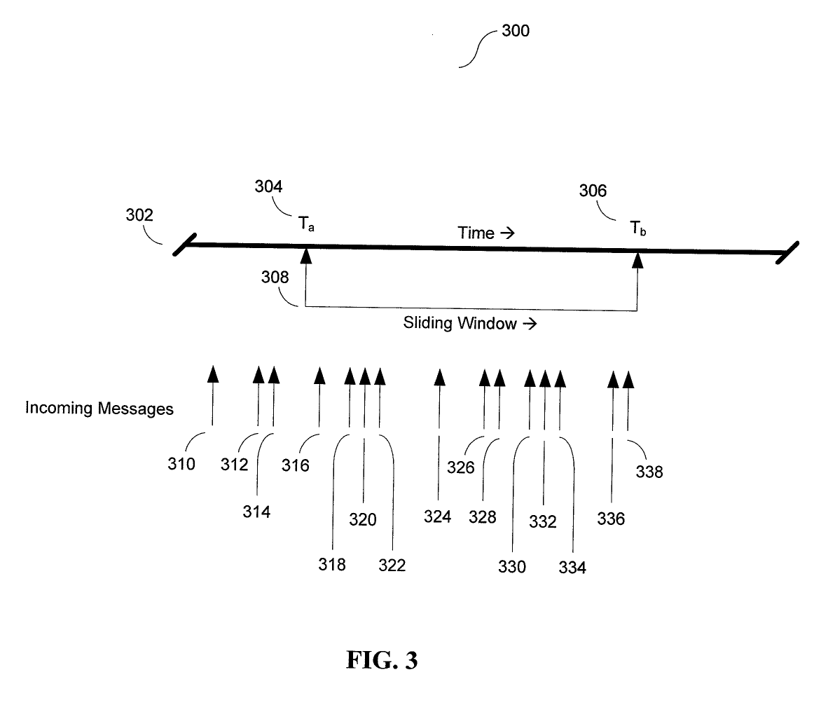

ii) Frequency Count. For example, the number or count of incoming messages (in total, for a specific SA, for an explicit range of SAs, etc.) within a sliding window. A sliding window 308 may be dynamically configurable to be a specific size or duration. An illustrative sliding window facility is depicted in FIG. 3 and reference numeral 300, wherein only certain ones of multiple messages 310-338 are analyzed between a start time Ta 304 and an end time Tb 306 over a timeline 302.

iii) Time of Day (ToD). For example, the 23 hours of a day—0, 1, 2, . . . , 23, and 24—based on any of several possible reference points (including, possibly inter alia, a local time zone, Greenwich Mean Time, etc.).

iv) Day of Week (DoW). For example, the seven days of a week—Sunday, Monday, . . . , Friday, and Saturday.

v) Source Carrier. For example, one specific source carrier (such as, for example, Verizon Wireless, T-Mobile, etc.). Or a mix or collection of specific source carriers.

The specific SF elements that were described above are illustrative only and it will be readily apparent to one of ordinary skill in the relevant art that numerous other factors are easily possible and indeed are fully within the scope of the present invention.

One or more SF elements may optionally be assigned a Weighting Factor (WF) to incrementally increase or decrease the importance or impact of an element to that element's relative contribution to a SF. As one possible example, a WF may be defined to lie within the range 0<=WF<=1 (with the boundary values of 0 and 1 indicating ‘no weight’ [for 0] and ‘neutral weight’ [for 1]). As another possible example, a WF may be allowed to span a wider range of values (with, possibly inter alia, an associated modulus or other scaling mechanism to ensure that a final or end calculated value never exceeds a configurable threshold such as 100%).

A SF may optionally default to ‘no impact or effect.’

Multiple SFs may be defined with, possibly inter alia, specific SFs being automatically or manually enabled or disabled based on one or more criteria including, for example, ToD, DoW, etc.

Multiple SFs may, for example for purposes of management and administration, be aggregated into one or more SF Groups (SFGs).

The SF characteristics that were described above are illustrative only and it will be readily apparent to one of ordinary skill in the relevant art that numerous other options are easily possible and indeed are fully within the scope of the present invention.

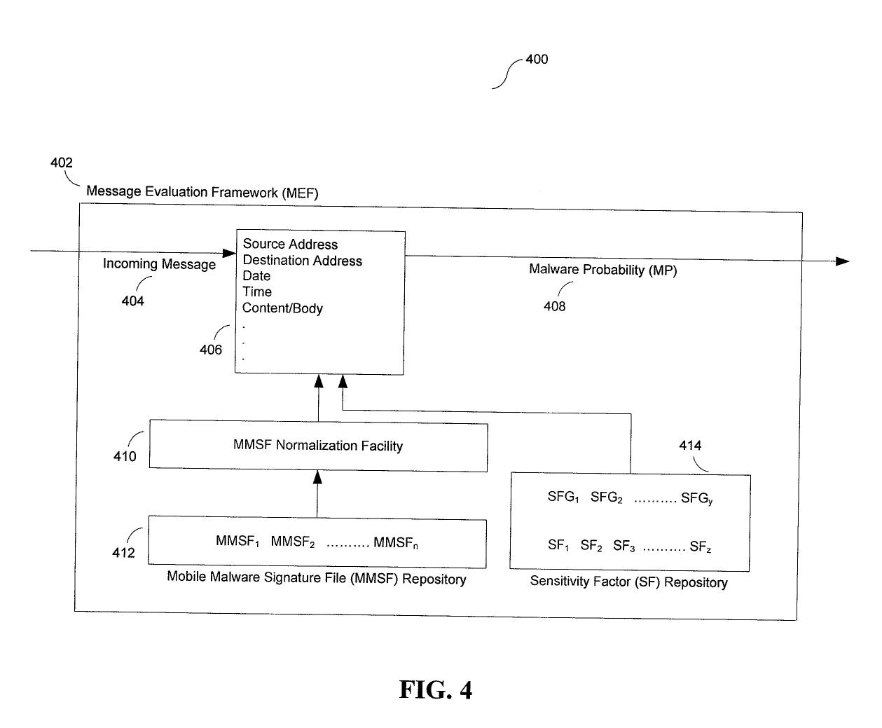

A graphical depiction of a hypothetical MEF may be found in FIG. 4 and reference numeral 400, which illustrates schematically (a) the acceptance of an incoming message 404 as input, (b) the controlled application of, possibly inter alia, one or more MMSFs and/or one or more SFs 406, and (c) the generation of a MP 408 as output.

The elements of the MEF that were described above are illustrative only and it will be readily apparent to one of ordinary skill in the relevant art that numerous other options are easily possible (e.g., any or all of the MMSFs, calculations, values [such as SFs], etc. that were described above might optionally be made WC-specific, MICV-specific, etc.) and indeed are fully within the scope of the present invention.

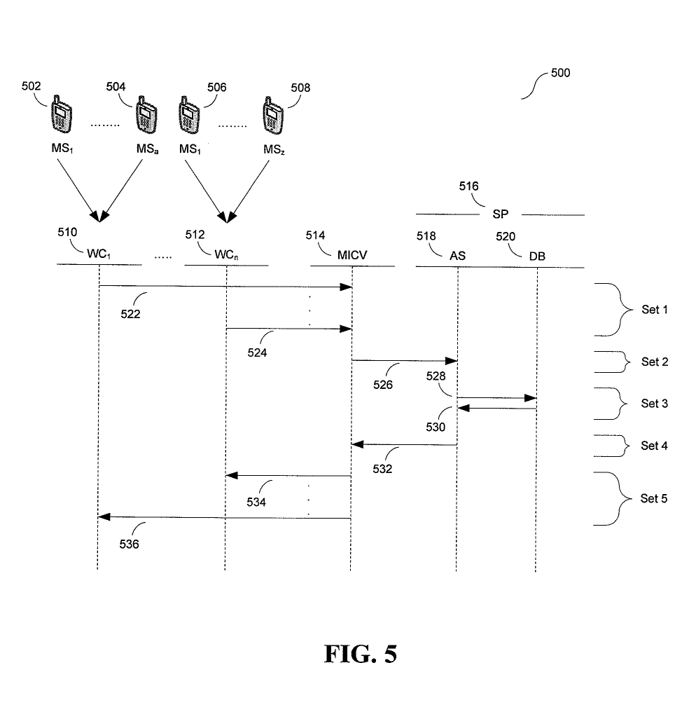

To help explain key aspects of the present invention consider the illustrative interactions that are depicted in FIG. 5 and reference numeral 500 (which capture various of the exchanges or interactions that might occur as [MMS, etc.] messaging traffic is generated, routed, processed, etc.) Of interest and note in the diagram are the following entities:

MS₁ 502→MSₐ 504 and MS₁ 506→MS_{z} 508. MS WDs such as a mobile telephones, BlackBerrys, PalmPilots, etc.

WC₁ 510→WCₙ 512. Numerous WCs.

MICV 514. As noted above the use of a MICV, although not required, provides significant advantages.

SP 516 AS 518. Facilities that provide key elements of the instant invention (which will be described below).

SP 516 Database (DB) 520. One or more data repositories that are leveraged by a AS 518 of SP 516.

In the discussion to follow reference is made to messages that are sent, for example, between a MS 502→504/506→508 and an SP 516. As set forth below, a given “message” sent between a MS 502→504/506→508 and a SP 516 may actually comprise a series of steps in which the message is received, forwarded and routed between different entities, including a WD associated with a MS 502→504/506→508, a WC 510→512, a MICV 514, and a SP 516. Thus, unless otherwise indicated, it will be understood that reference to a particular message generally includes that particular message as conveyed at any stage between an origination source, such as a WD of a MS 502→504/506→508, and an end receiver, such as a SP 516. As such, reference to a particular message generally includes a series of related communications between, for example, a MS 502→504/506→508 and a WC 510→512, the WC 510→512 and a MICV 514, and the MICV 514 and a SP 516. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

In FIG. 5 the exchanges that are collected under the designation Set 1 and Set 2 represent the activities that might take place as (MMS, etc.) messages are routed by the various WCs to a MICV (via 522→524) and then directed, by the MICV, to SPₓ 516 (via 526). It is important to note these exchanges are illustrative only and it will be readily apparent to one of ordinary skill in the relevant art that numerous other exchanges are easily possible and indeed are fully within the scope of the present invention.

In FIG. 5 the exchanges that are collected under the designation Set 3, Set 4, and Set 5 represent the activities that might take place as (MMS, etc.) messages are processed by SPₓ 516 (specifically by an AS 518 of SPₓ 516). To provide context for our review of the Set 3, Set 4, and Set 5 exchanges we take a brief detour to describe an illustrative SP AS.

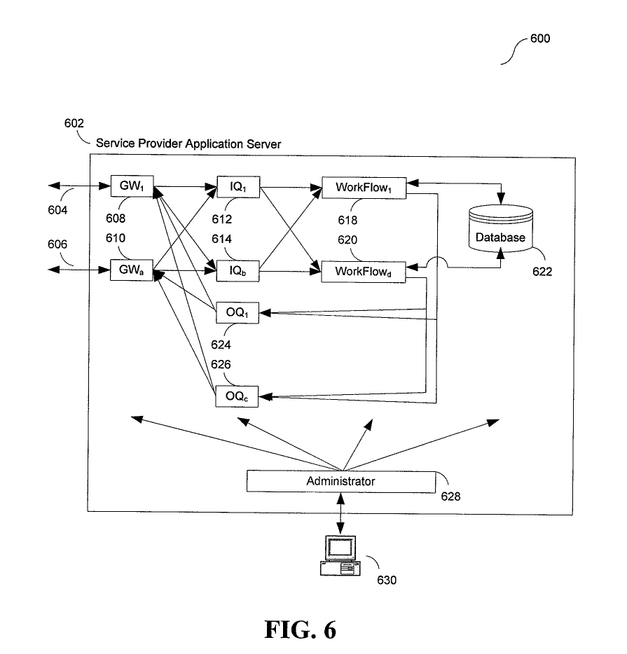

FIG. 6 and reference numeral 600 provide a diagrammatic presentation of aspects of an exemplary SP AS 602. The illustrated AS 602 contains several key components—Gateways (GW₁ 608→GWₐ 610 in the diagram), Incoming Queues (IQ₁ 612→IQ_{b} 614 in the diagram), WorkFlows (WorkFlow₁ 618→WorkFlow_{d} 620 in the diagram), Database 622, Outgoing Queues (OQ₁ 624→OQ_{c} 626 in the diagram), and an Administrator 628. It will be readily apparent to one of ordinary skill in the relevant art that numerous other components are possible within an AS 602.

A dynamically updateable set of one or more Gateways (GW₁ 608→GWₐ 610 in the diagram) handle incoming (MMS/IMS/etc. messaging, etc.) traffic 604→606 and outgoing (Short Message Service (SMS)/MMS/IMS/etc. messaging, etc.) traffic 604→606. Incoming traffic 604→606 is accepted and deposited on an intermediate or temporary Incoming Queue (IQ₁ 612→IQ_{b} 614 in the diagram) for subsequent processing. Processed artifacts are removed from an intermediate or temporary Outgoing Queue (OQ₁ 624→OQ_{c} 626 in the diagram) and then dispatched 604→606.

A dynamically updateable set of one or more Incoming Queues (IQ₁ 612→IQ_{b} 614 in the diagram) and a dynamically updateable set of one or more Outgoing Queues (OQ₁ 624→OQ_{c} 626 in the diagram) operate as intermediate or temporary buffers for incoming and outgoing traffic 604→606.

A dynamically updateable set of one or more WorkFlows (WorkFlow₁ 618→WorkFlow_{d} 620 in the diagram) remove incoming traffic 604→606 from an intermediate or temporary Incoming Queue (IQ₁ 612→IQ_{b} 614 in the diagram), perform all of the required processing operations (explained below), and deposit processed artifacts on an intermediate or temporary Outgoing Queue (OQ₁ 624→OQ_{c} 626 in the diagram). The WorkFlow component will be described more fully below.

The Database 622 that is depicted in FIG. 6 is a logical representation of the possibly multiple physical repositories that may be implemented to support, inter alia, configuration, word catalog, calculation, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 628 provides management or administrative control over all of the different components of an AS 602 through, as one example, a World Wide Web (WWW)-based interface 630. It will be readily apparent to one of ordinary skill in the relevant art that numerous other interfaces (e.g., an Application Programming Interface [API], a data feed, etc.) are easily possible.

Through flexible, extensible, and dynamically updatable configuration information a WorkFlow component may be quickly and easily realized to support any number of activities. For example, WorkFlows might be configured to support the receipt and processing of incoming (MMS, IMS, etc.) messages; to support the scanning of the body or content of a received message (using, for example, the MEF that was described previously); to support the generation and dispatch of outgoing alert, update, etc. messages; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, processing, etc. activities may be recorded. Among other things, such a repository may be used to support:

1) Scheduled (e.g., daily, weekly, etc.) and/or on-demand reporting with report results delivered through SMS, MMS, IMS, etc. messages; through E-mail; through a WWW-based facility; through Instant Messaging (IM); through an Interactive Voice Response (IVR) facility; etc.

2) Scheduled and/or on-demand data mining initiatives (possibly leveraging or otherwise incorporating one or more external data sources) with the results of same presented through visualization, Geographic Information System (GIS), etc. facilities and delivered through SMS, MMS, IMS, etc. messages; through E-mail; through a WWW-based facility; trough IM; through an IVR facility; etc.

Generated reports may include, possibly inter alia, a summary of infected messages (e.g., by ToD, by DoW, by day, by week, by month, etc.) for any number of constraints (e.g., malware types, source addresses, etc.), a list of the specific source address(es) that contained infected messages, historical summaries, trend analysis, the results of data mining operations, etc. Generated reports may contain, possibly inter alia, textual and graphic elements.

Over time as ever more messages are presented to a SP the SP may continuously expand the depth and/or the breadth of its internal repositories, and consequently incrementally refine, improve, etc. the quality, etc. of its message review and other analytical activities including generation of ever more malware detection probabilities.

Returning to FIG. 5 . . . the processing activities that are depicted under the designation Set 3, Set 4, and Set 5 might include, possibly inter alia (via, among other things, 528→530):

A) Retrieving an incoming message from an IQ.

B) Extracting from a received message, and optionally validating/etc., various data elements including, inter alia, the SA (such as, for example, the source TN), the Destination Address (such as, for example, the destination TN), the message content or body, etc.

C) Preserving various elements of the received message in a Messages database table.

D) Updating a MS database table, as appropriate and as required, to ensure that an entry exists for the SA (such as, for example, the TN) of the message.

E) Performing one or more analytical steps. The analytical steps may be realized through a combination of:

i) Flexible, extensible, and dynamically configurable Workflows (as previously described) that implement the rules, logic, etc. for a range of methods (including, inter alia, statistical, pattern matching, stylistic, linguistic, heuristic, etc.) that implement the MEF as described above.

ii) Dynamically updateable data sources (including, possibly inter alia, the MMSFs that were described above).

and may, possibly among other things, optionally score, rate, rank, etc. the developed results; optionally augment the developed results with internal and/or external demographic, geographic, etc. data; etc.

F) Generating one or more indicators. Indicators may capture, inter alia, specific characteristics (e.g., based on a MEF-generated MP a finding that a specific message contains one or more instances of malware), patterns, traits, features, etc.

G) Preserving one or more of the generated indicators in an Indicators database table.

H) Leveraging a flexible, extensible, and dynamically configurable list of defined events (e.g, as maintained in an EventDefinitions database table) to generate one or more events. Events may include, inter alia, alerting one or more parties (such as, for example, a WC, a MICV, etc.) to the presence of an infected message through any combination of one or more channels such as SMS/MMS/etc. messages, E-mail messages, IM messages, data feeds; optionally blocking an infected message; optionally dynamically updating one or more (SA, etc.) entries in a MEF SF; etc.

I) Depositing one or more of the generated events on an OQ.

J) Preserving one or more of the generated events in an Events database table.

K) Depositing, consistent with the generated indicator(s) and event(s), the incoming message on an OQ (for dispatch, e.g., first back to a MICV and then back to the appropriate WC for final delivery to the appropriate WD). For example, if an incoming message is not identified as containing malware then it may be deposited on an OQ. Alternatively, if an incoming message is identified being infected it may, depending upon previously-identified MICV and/or WC preferences, be blocked or dropped (and hence not deposited on an OQ).

The catalog of processing steps that were described above are illustrative only and it will be readily apparent to one of ordinary skill in the relevant art that numerous other processing steps (such as, possibly inter alia, scoring, ranking, rating, etc. one or more of the generated indicators) are easily possible and indeed are fully within the scope of the present invention. For example:

1) An incoming message that is identified as containing malware may optionally be ‘quarantined’ for, possibly inter alia, subsequent review (by representatives of a MICV, a WC, etc.).

2) An incoming message that is identified as containing malware may optionally be ‘cleansed.’Cleansing may consist of, possibly inter alia, one or more of such illustrative actions as (a) removing from the message an entire piece of content (e.g., executable code, multimedia, etc.) where the piece of content is identified as being infected with one or more instances of malware, (b) excising from a piece of content (e.g., executable code, multimedia, etc.) each of the identified instances of malware, (c) replacing in the message an entire piece of content (e.g., executable code, multimedia, etc.) with a piece of Phantom Content where the original content is identified as being infected with one or more instances of malware, (c) etc. A cleansed message may optionally be re-processed to ensure that the cleansed message is not infected.

3) An incoming message that is identified as containing malware may optionally result in one or more outgoing (SMS, MMS, etc.) alert, notification, etc. messages (to, for example, one or more representatives of a MICV, a WC, etc.).

4) An incoming message that is identified as containing malware may optionally result in one or more alternative lower-level (e.g., protocol, etc.) actions. For example, in the case of an infected MMS message a tailored MM4 negative acknowledgement message (such as ‘Malware Detected’) may be generated (from, for example, a body of dynamically configurable definitional information) and dispatched from either of MICV 514 or AS 518. For example, in the case of an infected MMS message one or more headers may be created (from, for example, a body of dynamically configurable definitional information) and included in an outgoing Simple Mail Transfer Protocol (SMTP) message.

5) Various of the elements that were described above might optionally be made WC-specific, MICV-specific, etc.

6) An optional registration process may be provided (through, possibly inter alia, a WWW site, an exchange of SMS/MMS/etc. messages, an IVR facility, an exchange of E-mail messages, etc.) by which, possibly inter alia, one or more representatives of a MICV, a WC, etc. may identify themselves, provide contact information, etc.

A SP may optionally offer one or more of the processing steps, reporting capabilities, etc. that were described above as value-add services for which, possibly inter alia, a SP may charge a fee. In support of same a SP may offer a range of billing mechanisms that may involve, possibly inter alia, different external entities (e.g., a WC's billing system, a carrier billing system service bureau, a credit or debit card clearinghouse, etc.) and/or internal entities. For example, if a SP elects to leverage a WC's billing system then the exemplary mechanics and logistics that are described in pending U.S. patent application Ser. No. 10/837,695 entitled “SYSTEM AND METHOD FOR BILLING AUGMENTATION” may, possibly among other things, be applied.

It is important to note the exchanges that were described above (as residing under the designation Set 3, Set 4, and Set 5 in FIG. 5) are illustrative only and it will be readily apparent to one of ordinary skill in the relevant art that numerous other exchanges are easily possible and indeed are fully within the scope of the present invention.

It will be readily apparent to one of ordinary skill in the relevant art that numerous alternatives to the different arrangements that were described above are easily possible.

The various alert, notification, report, etc. message(s) and/or Phantom Content that was described above may optionally contain an informational element—e.g., a service announcement, a relevant or applicable factoid, etc. that may be unrelated to the original (perhaps now-excised) content. The informational element may be selected statically (e.g., all generated messages are injected with the same informational text), selected randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a Location-Based Service (LBS)/Global Positioning System (GPS) facility).

A SP may optionally allow advertisers to register and/or provide (e.g., directly, or through links/references to external sources) advertising content.

The provided advertising content may optionally be included in various of the message(s) and/or Phantom Content that was described above—e.g., textual material, multimedia (images of brand logos, sound, video snippets, etc.) material, etc. The advertising material may be selected statically (e.g., all generated messages are injected with the same advertising material), selected randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS/GPS facility).

The message(s) and/or Phantom Content that was described above may optionally contain promotional materials, coupons, etc. (via, possibly inter alia, text, still images, video clips, etc.).

It is important to note that while aspects of the discussion that was presented above focused on the use of TNs, it will be readily apparent to one of ordinary skill in the relevant art that other message address identifiers are equally applicable and, indeed, are fully within the scope of the present invention.

The discussion that was just presented referenced the specific wireless messaging paradigm MMS. However, it is to be understood that it would be readily apparent to one of ordinary skill in the relevant art that other messaging paradigms (IMS, WAP, E-mail, etc.) are fully within the scope of the present invention.

It is important to note that the hypothetical example that was presented above, which was described in the narrative and which was illustrated in the accompanying figures, is exemplary only. It is not intended to be exhaustive or to limit the invention to the specific forms disclosed. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| API | Application Programming Interface |
| AS | Application Server |
| CSC | Common Short Code |
| DB | Database |
| DBMS | Database Management System |
| DoW | Day of Week |
| E-mail | Electronic Mail |
| GIS | Geographic Information System |
| GPS | Global Positioning System |
| GW | Gateway |
| IM | Instant Messaging |
| IMS | IP Multimedia Subsystem |
| IP | Internet Protocol |
| IQ | Incoming Queue |
| IVR | Interactive Voice Response |
| LBS | Location Based Services |
| MEF | Message Evaluation Framework |
| MICV | Messaging Inter-Carrier Vendor |
| MMS | Multimedia Message Service |
| MMSF | Mobile Malware Signature File |
| MP | Malware Probability |
| MS | Mobile Subscriber |
| ODBMS | Object Database Management System |
| OQ | Outgoing Queue |
| RDBMS | Relational Database Management System |
| SA | Source Address |
| SC | Short Code |
| SF | Sensitivity Factor |
| SFG | Sensitivity Factor Group |
| SMS | Short Message Service |
| SMTP | Simple Mail Transfer Protocol |
| SP | Service Provider |
| TN | Telephone Number |
| ToD | Time of Day |
| WAP | Wireless Application Protocol |
| WC | Wireless Carrier |
| WD | Wireless Device |
| WF | Weighting Factor |
| WWW | World-Wide Web |

What is claimed is:

1. A method for controlling malware within a wireless ecosystem, comprising:
receiving a plurality of messages passing through a wireless ecosystem, the messages being considered received messages;
performing one or more analytic steps on the received messages within a Message Evaluation Framework;
generating one or more indicators in view of results of the analytic steps;
generating one or more events in view of the indicators and a list of previously defined events; and
disposing of the received messages consistent with the generated events.

2. The method of claim 1, wherein elements of one or more of (a) the received messages, (b) results of the analytic steps, (c) the indicators, (d) the events, and/or (e) disposition of the received messages are preserved in a repository.

3. The method of claim 1, wherein a received message that is identified as containing malware result in one or more of (a) the dropping of the received message, (b) the quarantine of the received message, (c) the cleansing of the received message, (d) the generation of one or more alert messages, and/or (e) the generation of one or more lower-level protocol actions.

4. The method of claim 3, wherein the cleansing operation comprises replacing content considered malware with Phantom Content.

5. The method of claim 3, wherein an alert message is one or more of (a) a Short Message Service message and/or (b) a Multimedia Message Service message.

6. The method of claim 1, wherein the Message Evaluation Framework supports one or more of (a) a dynamic catalog of Mobile Malware Signature Files, (b) a Mobile Malware Signature File normalization facility, and/or (c) sensitivity factors.

7. The method of claim 6, wherein the sensitivity factor is employed to calculate a probability of whether a given received message contains malware.

8. The method of claim 6, wherein a sensitivity factor is based on one or more of (a) source address, (b) frequency count, (c) time of day, (d) day of week, and/or (e) source carrier.

9. The method of claim 8, wherein the frequency count is determined through a sliding window.

10. The method of claim 8, wherein a weighting factor is maintained for an element of a sensitivity factor.

11. A method for detecting messages containing malware traversing a wireless network, comprising:
intercepting a message at a messaging inter-carrier vendor (MICV) that was sent over a wireless network; and
passing the message to an application server that is in communication with a database, and calculating by the application server a probability that the message contains malware,
wherein the calculating comprises analyzing the content the message.

12. The method of claim 11, further comprising comparing portions of the message to a plurality of mobile malware signature files.

13. The method of claim 12, wherein the plurality of mobile malware signature files are generated based on one or more of publicly available freeware, shareware or open source commercial sources.

14. The method of claim 13, wherein a mobile malware signature file comprises a binary pattern.

15. The method of claim 11, further comprising identifying a portion of the content as malware.

16. The method of claim 15, further comprising replacing the portion of the content with phantom content.

17. The method of claim 16, wherein the phantom content includes an information element unrelated to the now-excised content.

18. The method of claim 16, further comprising sending the message with the phantom content back to the application for re-calculation of a probability that the message with the phantom content contains malware.

19. The method of claim 16, further comprising generating and sending an MM4 negative acknowledgement message in view of an instance of detected malware in the message.

20. The method of claim 11, wherein the message is a multimedia message service (MMS) message.
